(19) United States
(12) Patent Application Publication
(10) Pub. No.: US 2020/0001369 A1
(43) Pub. Date: Jan. 2, 2020

(54) METHOD FOR MANUFACTURING SOFT MAGNETIC IRON POWDER

(71) Applicant: JFE STEEL CORPORATION, Tokyo (JP)

(72) Inventors: Makoto NAKASEKO, Tokyo (JP); Naomichi NAKAMURA, Tokyo (JP); Mineo MURAKI, Tokyo (JP); Takuya TAKASHITA, Tokyo (JP)

(73) Assignee: JFE Steel Corporation, Tokyo (JP)

(21) Appl. No.: 16/480,780

(22) PCT Filed: Jan. 25, 2018
(86) PCT No.: PCT/JP2018/002228

§ 371 Date: Jul. 25, 2019

(30) Foreign Application Priority Data
Jan. 27, 2017 (JP) 2017-013604

(51) Int. Cl. B22F 9/08; C22C 45/02; H01F 1/153

(52) U.S. Cl. CPC B22F 9/082; C22C 45/02; B22F 2301/35; B22F 2009/0828; H01F 1/15308

(57) ABSTRACT

Provided is a method for manufacturing soft magnetic iron powder.

A method for manufacturing soft magnetic iron powder, the method including ejecting high-pressure water to collide with a molten metal stream falling vertically downward, breaking up the molten metal stream into metal powder, and cooling the metal powder, in which, when a falling rate of the molten metal stream per unit time is defined as Qm (kg/min) and an ejection rate of high-pressure water per unit time is defined as Qaq (kg/min), a mass ratio (Qaq/Qm) is 50 or more, and a total content of ferrous constituents (Fe, Ni, and Co) is 76 at % or more.

### CROSS REFERENCE TO RELATED APPLICATIONS

This is the U.S. National Phase application of PCT/JP2018/002228, filed Jan. 25, 2018, which claims priority to Japanese Patent Application No. 2017-013604, filed Jan. 27, 2017, the disclosures of these applications being incorporated herein by reference in their entireties for all purposes.

### FIELD OF THE INVENTION

The present invention relates to a method for manufacturing soft magnetic iron powder by using a water atomization method (hereinafter, also referred to as “water-atomized metal powder”), and in particular, relates to improving the amorphous material fraction of soft magnetic iron powder.

### BACKGROUND OF THE INVENTION

In a water atomization method, atomized metal powder is obtained by breaking up a molten metal stream into powdery metal (metal powder) with water jets ejected from, for example, nozzles and cooling the powdery metal (metal powder) with the water jets. On the other hand, in a gas atomization method, atomized metal powder is usually obtained by breaking up a molten metal stream into powdery metal with an inert gas ejected from nozzles and then causing the powdery metal (metal powder) to drop into a water tank or a flowing-water drum located under an atomizing apparatus to cool the powdery metal.

As a method for manufacturing metal powder, water atomization has high production capability with low cost as compared to gas atomization. In the case of gas atomization, it is necessary to use an inert gas for atomization, and gas atomization is inferior to water atomization from the viewpoint of atomizing energy. In addition, while metal powder particles manufactured by gas atomization have an almost spherical shape, metal powder particles manufactured by water atomization have irregular shapes. Therefore, when metal powder is formed into, for example, a motor core by performing compaction forming, irregularly shaped metal powder particles manufactured by water atomization have an advantage over spherically shaped metal powder particles manufactured by gas atomization in that metal powder particles are likely to entangle with each other to increase strength after compaction has been performed.

Nowadays, from the viewpoint of energy saving, there is a demand for reducing the iron loss and size of a motor core which is used for, for example, an electric automobile or a hybrid automobile. To date, such a motor core has been manufactured by placing thin electrical steel sheets on top of one another. However, nowadays, a motor core manufactured by using metal powder, which has a high design freedom in shape, is receiving much attention. To reduce iron loss of such a motor core, using non-crystalline (amorphous) metal powder is considered effective. To manufacture amorphous metal powder, it is necessary that, while atomizing high-temperature molten metal, atomized metal powder be rapidly cooled by using a coolant to prevent crystallization. In addition to reducing iron loss, it is necessary to increase magnetic flux density for reducing motor size and increasing motor power. To increase magnetic flux density, ferrous material concentration (including Ni and Co) is important, and there is a demand for soft magnetic iron powder, which is an amorphous soft magnetic metal powder for a motor core having a ferrous material concentration of about 76 at % to 90 at %.

When high-temperature molten metal (above-described broken-up metal powder) is cooled with water, water is instantly vaporized at the time of contact between the water and the molten metal to form a vapor film around the molten metal, and direct contact between a surface to be cooled and water is suppressed (film boiling occurs), which results in a stagnation in cooling rate.

To solve the problem of stagnation in cooling rate due to a vapor film or film boiling when manufacturing amorphous iron powder, investigations have been conducted to date. For example, Patent Literature 1 describes a technique of removing a surrounding vapor film by placing a device, through which a second liquid is ejected, under an atomizing apparatus and by controlling the ejection pressure of the liquid to be 5 MPa to 20 MPa to forcibly change the moving direction of a fluid dispersion containing molten metal.

### PATENT LITERATURE

PTL 1: Japanese Unexamined Patent Application Publication No. 2007-291454

### SUMMARY OF THE INVENTION

The technique described in Patent Literature 1 states that it is possible to remove a vapor film by changing the moving direction of a fluid dispersion containing molten metal droplets after atomization with a liquid jet spray. However, in the case where the temperature of the molten metal surrounded by a vapor film is excessively high when the moving direction is changed, the molten metal may be covered with a vapor film again due to surrounding cooling water. On the contrary, in the case where the temperature of the molten metal is excessively low when the molten metal collides with a cooling block, the molten metal may solidify and the crystallization may progress. In particular, in the case where the amounts of ferrous elements (Fe, Co, and Ni) are large, cooling start temperature is high due to high melting point, and there is a tendency for film boiling to occur at the beginning of cooling. Therefore, it may be said that this technique is not sufficient to solve the problem.

Aspects of the present invention have been completed to solve the problem described above, and an object according to aspects of the present invention is to provide a method for manufacturing soft magnetic iron powder with which it is possible to effectively increase an amorphous material fraction of the soft magnetic iron powder, even in the case where the amounts of ferrous elements (Fe, Co, and Ni) are large.

The present inventors diligently conducted investigations to solve the problem described above and, as a result, found that, when the falling rate of a molten metal stream per unit time is defined as Qm (kg/min) and the ejection rate of high-pressure water per unit time is defined as Qaq (kg/min), there is a correlation between a mass ratio (Qaq/Qm) and the amorphous material fraction of soft magnetic iron powder, resulting in the completion of the present invention. The subject matter according to aspects of the present invention is as follows.

[1] A method for manufacturing soft magnetic iron powder, the method including ejecting high-pressure water to collide with a molten metal stream falling vertically downward, breaking up the molten metal stream into metal powder, and cooling the metal powder, in which, when a falling rate of the molten metal stream per unit time is defined as Qm (kg/min) and an ejection rate of the high-pressure water per unit time is defined as Qaq (kg/min), a mass ratio (Qaq/Qm) is 50 or more, and a total content of ferrous constituents (Fe, Ni, and Co) is 76 at % or more.

[2] The method for manufacturing soft magnetic iron powder according to item [1], in which an ejection pressure of the high-pressure water is 25 MPa to 60 MPa, and the total content of the ferrous constituents is 78 at % or more.

[3] The method for manufacturing soft magnetic iron powder according to item [1] or [2], in which a temperature of the high-pressure water is 20° C. or lower, and the total content of the ferrous constituents is 80 at % or more.

[4] A method for manufacturing soft magnetic iron powder, the method including ejecting high-pressure water to collide with a molten metal stream falling vertically downward, breaking up the molten metal stream into metal powder, and cooling the metal powder, in which when a falling rate of the molten metal stream per unit time is defined as Qm (kg/min) and an ejection rate of the high-pressure water per unit time is defined as Qaq (kg/min), a mass ratio (Qaq/Qm) is controlled on the basis of a correlation between the mass ratio (Qaq/Qm) and an amorphous material fraction of soft magnetic iron powder to achieve a desired amorphous material fraction, and a total content of ferrous constituents (Fe, Ni, and Co) is 76 at % or more.

[5] The method for manufacturing soft magnetic iron powder according to item [4], in which the mass ratio is controlled by controlling a diameter of a teeming nozzle bore, through which the molten metal stream falls downward, and/or by controlling an ejection pressure of the high-pressure water.

According to aspects of the present invention, soft magnetic iron powder, which is amorphous powder containing mainly ferrous elements (including Ni and Co by which part of Fe is replaced), is able to be manufactured by using a water atomization method, and metal powder having a chemical composition with which it is possible to show excellent performance as a soft magnetic material can be produced in large quantity at low cost, which significantly contributes to the current trend toward resource saving and energy saving including, for example, the size reduction of a transformer and the reduction of the iron loss of a motor. By performing an appropriate heat treatment on this powder after forming, since crystals of a nanometer-order size are precipitated, it is possible to achieve both low iron loss and a high magnetic flux density.

In addition, it is possible to use aspects of the present invention for manufacturing, for example, any conventionally known amorphous soft magnetic material by water atomization. Nowadays, in addition, as described in, for example, Materia Japan, Vol. 41, No. 6, p. 392, the Journal of Applied Physics 105, 013922 (2009), Japanese Patent No. 4288687, Japanese Patent No. 4310480, Japanese Patent No. 4815014, International Publication No. WO2010/084900, Japanese Unexamined Patent Application Publication No. 2008-231534, Japanese Unexamined Patent Application Publication No. 2008-231533, and Japanese Patent No. 2710938, hetero-amorphous materials and nanocrystalline materials which have a high magnetic flux density are being developed. Aspects of the present invention is very advantageously suitable when used to manufacture such soft magnetic materials containing mainly Fe, Co, and Ni by water atomization. In particular, in the case where the total concentration (the total content of ferrous constituents) is more than 82.5 at %, since there is a significant increase in saturated magnetic flux density (Bs) when an amorphous material fraction after atomization is more than 90% and a particle diameter (average particle diameter) is 5 μm or more, the effects according to aspects of the present invention are markedly exerted. In addition, by applying aspects of the present invention to materials having chemical compositions out of the range described above, aspects of the present invention have an advantageous effect in that it is possible to stably obtain amorphous powder having a large particle diameter more easily than by using conventional methods.

### BRIEF DESCRIPTION OF THE DRAWINGS

FIG. 1 is a schematic view of an example of a manufacturing apparatus which can be used in the method for manufacturing soft magnetic iron powder according to aspects of the present invention.

FIG. 2 is a graph illustrating the results of the determination of amorphous material fraction to controlled various mass ratios (Qaq/Qm) in the case of a soft magnetic material whose total content of ferrous constituents is 76 at %.

FIG. 3 is a graph illustrating the effect of the ejection pressure of high-pressure water on the correlation between a mass ratio (Qaq/Qm) and the amorphous material fraction of soft magnetic iron powder.

FIG. 4 is a graph illustrating the effect of the temperature of high-pressure water on the correlation between a mass ratio (Qaq/Qm) and the amorphous material fraction of soft magnetic iron powder.

FIG. 5 is a schematic view illustrating a teeming nozzle bore diameter.

FIG. 6 is a graph illustrating an example of the relationship between a teeming nozzle bore diameter and a mass ratio (Qaq/Qm).

FIG. 7 is a schematic view illustrating an example of specific means for controlling the teeming nozzle bore diameter.

FIG. 8 is a schematic view illustrating an example of equipment for manufacturing water-atomized metal powder.

### DETAILED DESCRIPTION OF EMBODIMENTS OF THE INVENTION

Hereafter, embodiments of the present invention will be described. Here, the present invention is not limited to the embodiments below.

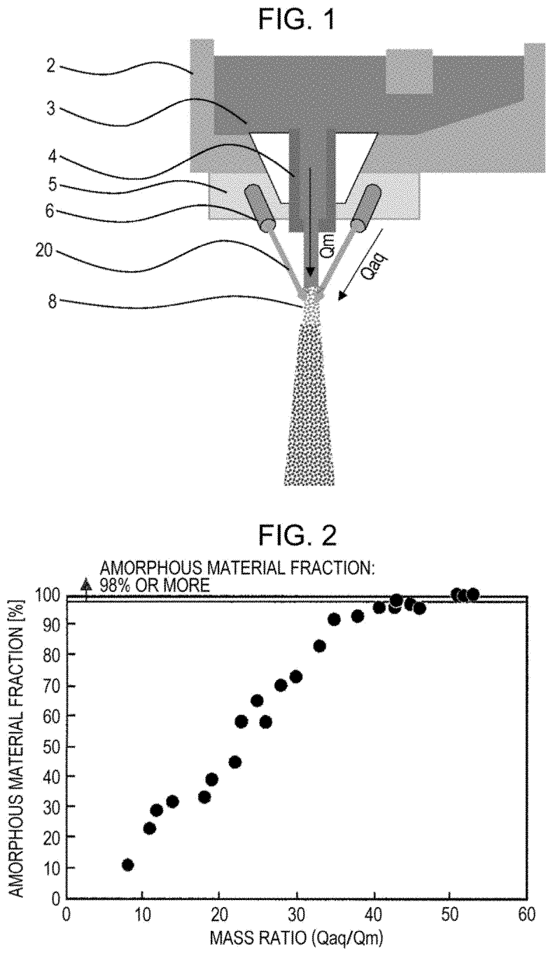

FIG. 1 shows a schematic view of an example of a manufacturing apparatus which can be used in the method for manufacturing soft magnetic iron powder according to aspects of the present invention. In FIG. 1, after molten metal 3 has been charged into a tundish 2, the molten metal 3 falls downward due to its weight through a molten metal-teeming nozzle 4, cooling water 20 (corresponding to high-pressure water) fed into a nozzle header 5 is ejected through cooling nozzles 6, and the cooling water 20 comes into contact with the molten metal (molten metal stream falling downward) so that the molten metal is atomized, that is, broken up into metal powder 8. Since the soft magnetic iron powder manufactured by applying aspects of the present invention has a total content of ferrous constituents (Fe, Ni, and Co) of 76 at % or more, it is necessary to control the total content of ferrous constituents (Fe, Ni, and Co) of the molten metal 3 to be 76 at % or more. Here, in accordance with aspects of the present invention, the term “high-pressure water” refers to a case where the ejection pressure of water is 10 MPa or more.

In FIG. 1, the falling rate of the molten metal falling downward through the molten metal-injecting nozzle per unit time is defined as Qm (kg/min), the total amount of the cooling water ejected from the cooling water-ejecting nozzles per unit time is defined as Qaq (kg/min), and a mass ratio between them is defined as Qaq/Qm (water/molten metal).

As described in detail below with reference to FIGS. 2 through 4, since there is a correlation between the mass ratio (Qaq/Qm) and the amorphous material fraction of soft magnetic iron powder produced, it is clarified that it is possible to increase the amorphous material fraction of soft magnetic iron powder by controlling the mass ratio (Qaq/Qm).

In addition, as indicated in FIGS. 2 through 4, it is clarified that the advantageous effects described below are obtained.

FIG. 2 is a graph illustrating the results of the determination of the amorphous material fractions to controlled various mass ratios (Qaq/Qm) in the case of a soft magnetic material whose total content of ferrous constituents is 76 at %. Here, “amorphous material fraction” is obtained, after removing contaminants which are different from metal powder from the obtained metal powder (soft magnetic iron powder), by performing X-ray diffractometry to determine halo peaks from amorphous materials (non-crystalline materials) and diffraction peaks from crystals, and by performing a calculation by utilizing a WPPD method. The term “WPPD method” is an abbreviation of “whole-powder-pattern decomposition method”. Here, a WPPD method is described in detail in Hideo Toraya, Journal of the Crystallographic Society of Japan, vol. 30 (1988), No. 4, pp. 253 to 258.

As indicated in FIG. 2, it is clarified that it is possible to increase the amorphous material fraction of soft magnetic iron powder to a very high value by controlling the mass ratio (Qaq/Qm). Specifically, by controlling the mass ratio (Qaq/Qm) to be 50 or more, the amorphous material fraction is increased to a very high value of about 98% or more. Here, although there is no particular limitation on the temperature of the high-pressure water in accordance with aspects of the present invention, it is preferable that the temperature be 35° C. or lower or more preferably 20° C. or lower.

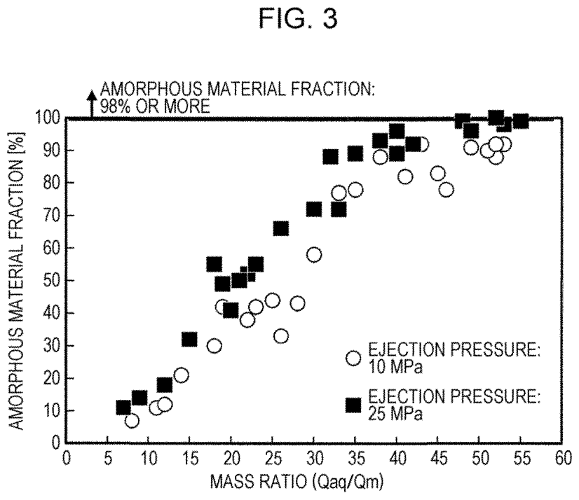

FIG. 3 is a graph illustrating the effect of the ejection pressure of the high-pressure water on the correlation between the mass ratio (Qaq/Qm) and the amorphous material fraction of soft magnetic iron powder. In addition, in FIG. 3, the total content of ferrous constituents is 78 at % or more. As indicated in FIG. 3, the total content of ferrous constituents being 78 at % or more, in the case where the ejection pressure of the high-pressure water is 10 MPa, it is not possible to achieve a very high amorphous material fraction of about 98% (represented by the white circles in FIG. 3). By the way, in the case of FIG. 2, although the ejection pressure of the high-pressure water is also 10 MPa, since the total content of ferrous constituents is slightly less than that in FIG. 3, it is possible to achieve a very high amorphous material fraction.

Here, in contrast, it is clarified that, in the case where the ejection pressure is 25 MPa, it is possible to achieve a very high amorphous material fraction by controlling the mass ratio (Qaq/Qm) to be 50 or more, even when the total content of ferrous constituents is 78 at %. From these results, it is clarified that it is possible to markedly increase the amorphous material fraction of soft magnetic iron powder by increasing ejection pressure, even in the case where the total content of ferrous constituents is 78 at % or more.

The reason why it is possible to achieve, even in the case where the total content of ferrous constituents is high, a markedly high amorphous material fraction by increasing ejection pressure is considered to be because it is possible to manufacture soft magnetic iron powder by cooling metal powder while destroying a vapor film.

Here, it is preferable that the upper limit of the ejection pressure be 60 MPa or less, because the upper limit of industrial pipework is generally 60 MPa, and because it is difficult to manufacture a valve through which a large amount of water is caused to flow in the case where the ejection pressure is more than 60 MPa. In addition, it is preferable that the total content of ferrous constituents be 82.5 at % or less in the case of the method utilizing ejection pressure, because it is possible to markedly increase the amorphous material fraction by controlling the ejection pressure to be 25 MPa to 60 MPa only in the case where the total content of ferrous constituents is 82.5 at % or less.

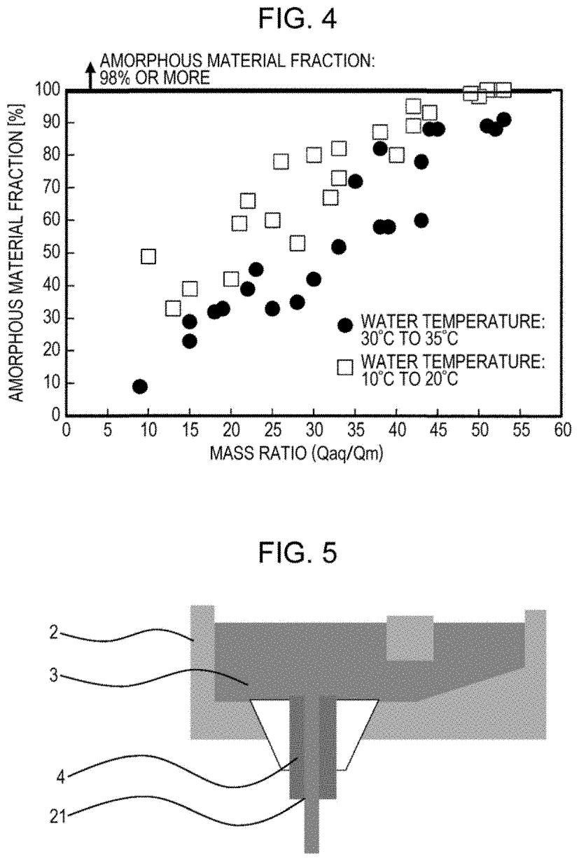

FIG. 4 is a graph illustrating the effect of the temperature of the high-pressure water on the correlation between the mass ratio (Qaq/Qm) and the amorphous material fraction of soft magnetic iron powder. In addition, in FIG. 4, the total content of ferrous constituents is 80 at % or more. In the case where the total content of ferrous constituents is 80 at % or more, since there is a further increase in melting point, there is an increase in cooling start temperature, which results in a tendency for a vapor film to be generated. Therefore, as indicated in FIG. 4, it is clarified that it is not possible to achieve a markedly high amorphous material fraction in the case of an ordinary water temperature of 30° C. to 35° C.

In the case of FIG. 4, a method in which the ejection pressure of the high-pressure water is increased as indicated by FIG. 3 is an effective method for increasing the amorphous material fraction.

As indicated in FIG. 4, it is clarified that it is possible to markedly increase the amorphous material fraction by decreasing the temperature of the high-pressure water without increasing ejection pressure, even in the case where the total content of ferrous constituents is high. Specifically, it is clarified that, by controlling the temperature of the high-pressure water to be about 20° C. (10° C. to 20° C.), and by controlling the mass ratio (Qaq/Qm) to be 50 or more, it is possible to markedly increase the amorphous material fraction of soft magnetic iron powder in the case where the total content of ferrous constituents is 80 at %. Therefore, it is clarified that it is possible to markedly increase the amorphous material fraction of soft magnetic iron powder by controlling the temperature of the high-pressure water to be 20° C. or lower, even in the case where the total content of ferrous constituents is 80 at % or more. Although a case where the temperature of the high-pressure water is 10° C. to 20° C. is illustrated as an example, the lower limit of the water temperature is 4° C., because it is possible to exert the effects according to aspects of the present invention as long as the water temperature is low and the water is not solidified.

In addition, it is preferable that the total content of ferrous constituents be 82.5 at % or less in the case of the method utilizing water temperature control, because it is possible to markedly increase the amorphous material fraction by controlling the water temperature to be 20° C. or lower only in the case where the total content of ferrous constituents is 82.5 at % or less.

In addition, also in the case of FIG. 3 (where the total content of ferrous constituents is 78 at %), it is possible to markedly increase the amorphous material fraction of soft magnetic iron powder by decreasing the temperature of the high-pressure water without increasing the ejection pressure of the high-pressure water.

As described above, either by decreasing the temperature of the high-pressure water, or by increasing the ejection pressure of the high-pressure water, it is possible to markedly increase the amorphous material fraction of soft magnetic iron powder in the case where the mass ratio (Qaq/Qm) is 50 or more. As described above, although difficulty in markedly increasing the amorphous material fraction of soft magnetic iron powder increases with an increase in the total content of ferrous constituents, it is possible to markedly increase the amorphous material fraction of soft magnetic iron powder by a combination of a method in which the temperature of the high-pressure water is decreased and a method in which the ejection pressure of the high-pressure water is increased, even in the case where the total content of ferrous constituents is very high. Here, the expression “the total content of ferrous constituents is very high” refers to a case where the total content of ferrous constituents is 80 at % or more. In addition, it is preferable that the total content of ferrous constituents be 85.0 at % or less in the case of the method utilizing both water temperature control and ejection pressure control, because it is possible to markedly increase the amorphous material fraction by controlling water temperature to be 20° C. or lower and by controlling ejection pressure to be 25 MPa to 60 MPa only in the case where the total content of ferrous constituents is 85.0 at % or less.

Hereafter, a method for controlling the mass ratio (Qaq/Qm) will be described. To control the mass ratio (Qaq/Qm), it is necessary to control the flow rate of a high-pressure water pump or the flow rate of the molten metal stream. In the case where the ejection pressure of the high-pressure water is fixed, since it is difficult to change the flow rate of the high-pressure water without changing cooling water-ejecting nozzle bodies, it is cumbersome to change the flow rate of the high-pressure water pump. Therefore, it is preferable that the mass ratio (Qaq/Qm) be controlled by controlling the flow rate of the molten metal stream. Specifically, the controlling method is as follows.

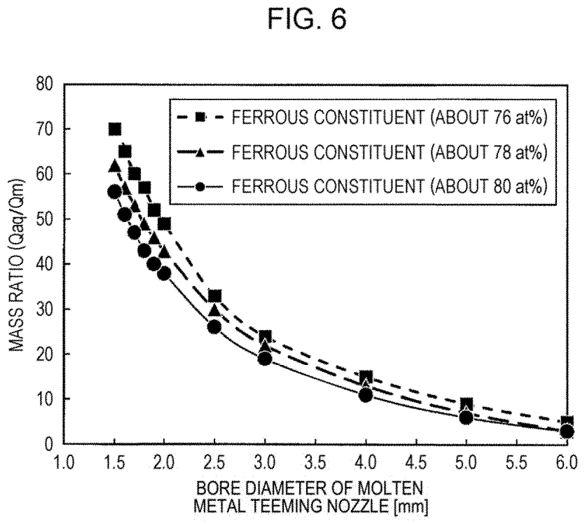

First, there is a method in which, as illustrated in FIG. 5, the teeming nozzle bore diameter 21 of the molten metal-injecting nozzle 4, which is a port through which the molten metal stream falls downward, is controlled to control the flow rate of the molten metal stream. Since Qm should be decreased to increase the mass ratio (Qaq/Qm), the teeming nozzle bore diameter should be decreased. To control the mass ratio (Qaq/Qm) to be 50 or more, first, it is necessary to determine which teeming nozzle bore diameter corresponds to a mass ratio (Qaq/Qm) of 50 or more. For this purpose, it is necessary to check the relationship between the teeming nozzle bore diameter and the mass ratio (Qaq/Qm) in advance. FIG. 6 is a graph illustrating an example of the relationship between the teeming nozzle bore diameter and the mass ratio (Qaq/Qm). As indicated in FIG. 6, it is clarified that, in the case where the total content of ferrous constituents is about 76 at % to 80 at %, it is preferable that the teeming nozzle bore diameter be about 1.5 mm to 1.9 mm and that the teeming nozzle bore diameter can be changed at intervals of 0.1 mm. The melting point is different depending on the total content of ferrous constituents. Since the melting point decreases and the viscosity increases with a decrease in the total content of ferrous constituents, it is necessary to increase the teeming nozzle bore diameter. In contrast, since the melting point increases and the viscosity decreases with an increase in the total content of ferrous constituents, it is necessary to decrease the teeming nozzle bore diameter. Thus, it is possible to predict an appropriate teeming nozzle bore diameter corresponding to predetermined ferrous constituents from the viewpoint of melting point by using the results of other investigations.

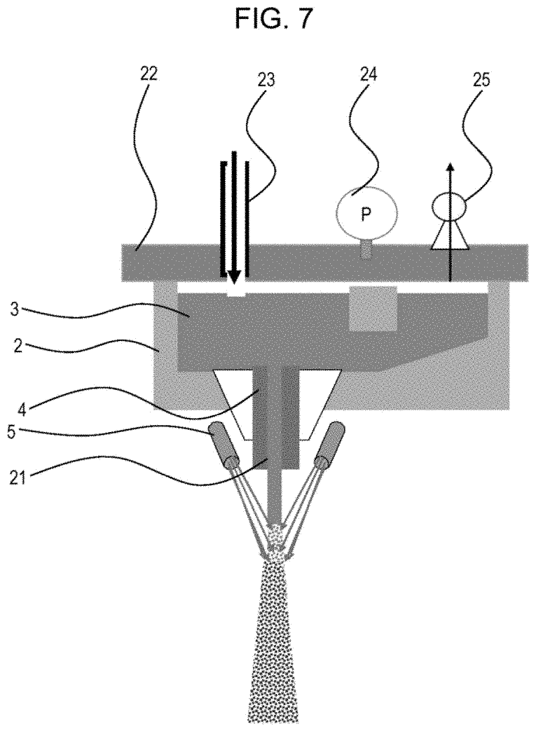

Specific means for controlling the teeming nozzle bore diameter will be described with reference to FIG. 7. As illustrated in FIG. 7, it is also effective to use a sealed-structure tundish 2 or place a tundish lid 22 after molten metal 3 has been charged into a tundish 2 and apply pressure to the molten metal 3 by injecting an inert gas into the tundish 2 through an inert gas-injecting port 23. After having set the injecting bore diameter 21 to be about 1.2 mm to 2.2 mm, the flow rate of the molten metal stream through the molten metal-injecting nozzle 4 is controlled by injecting the inert gas into the tundish. It is preferable that a pressure gauge 24 and a relief valve 25 be fitted to the tundish lid 22 and that the mass ratio (Qaq/Qm) be controlled by setting the pressure value of the relief valve 25. In the case where the teeming nozzle bore diameter 21 of the molten metal-injecting nozzle 4 is about 1.1 mm, since the molten metal is less likely to fall downward freely due to the surface tension of the molten metal, the molten metal solidifies in the nozzle before the pressure sufficiently increases even if pressure is applied. Therefore, it is preferable that the teeming nozzle bore diameter 21 be 1.2 mm or more. In addition, to control the mass ratio (Qaq/Qm) to be 50 or more, it is preferable that the teeming nozzle bore diameter 21 be 1.5 mm or less and that the applied pressure be about 0.05 MPa to 0.5 MPa. In the case where the teeming nozzle bore diameter is ϕ1.6 mm to ϕ2.2 mm, the molten metal can fall as free fall.

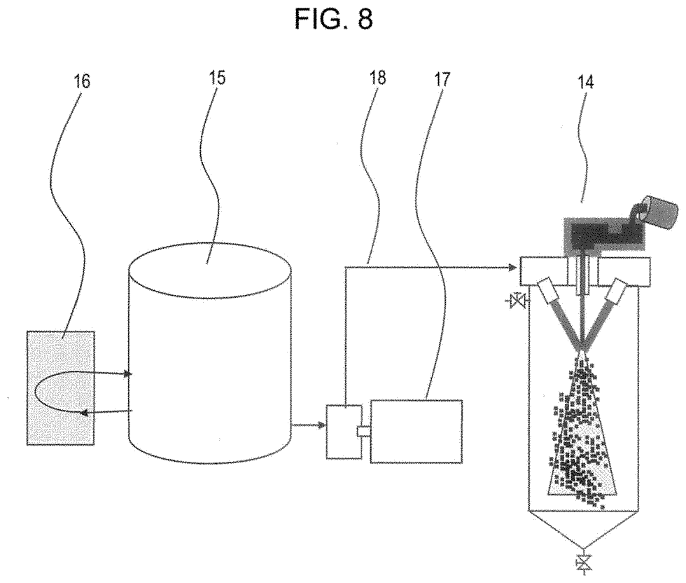

Hereafter, control of the temperature of the high-pressure water will be described with reference to FIG. 8. FIG. 8 is a schematic view illustrating an example of equipment for manufacturing water-atomized metal powder. In this manufacturing equipment, metal powder is manufactured: by controlling the temperature of cooling water in a cooling-water tank 15 by using a cooling water-temperature controller 16; by transporting the cooling water, whose temperature has been controlled, to a high-pressure pump 17 for atomizing cooling water; by transporting the cooling water from the high-pressure pump 17 for atomizing cooling water through pipework 18 for atomizing cooling water to an atomizing apparatus 14; and by ejecting from the atomizing apparatus 14 the high-pressure water, which collides with the molten metal stream falling vertically downward, to break up the molten metal stream into metal powder and to cool the metal powder.

It is possible to control the temperature of the cooling water to be a desired temperature by checking the temperature of the water in the cooling-water tank with a thermometer (unillustrated) and by using the cooling water-temperature controller 16.

Hereafter, a method for controlling the ejection pressure of the high-pressure water will be described. It is possible to control the ejection pressure by controlling the rotation speed of the high-pressure pump through inverter control. In addition, in the case where the flow rate of the water is controlled with a constant ejection pressure, it is possible to perform the control by changing the nozzle tips fixed to the cooling nozzle header.

Hereafter, the material for which aspects of the present invention are applied will be described. There is no particular limitation on the material for which the manufacturing method according to aspects of the present invention is applied, and aspects of the present invention may be used for manufacturing any conventionally known water-atomized amorphous soft magnetic material.

Aspects of the present invention are very advantageously suitable when used to manufacture soft magnetic materials containing mainly Fe, Co, and Ni by water atomization. In particular, in the case where the total concentration (the total content of ferrous constituents) is more than 82.5 at %, the effects according to aspects of the present invention is markedly exerted, since there is a significant increase in saturated magnetic flux density (Bs) when an amorphous material fraction after atomization is more than 90% and a particle diameter (average particle diameter) is 5 μm or more. In addition, aspects of the present invention have an advantageous effect that it is possible to stably obtain amorphous powder having a large particle diameter by applying aspects of the present invention to materials having chemical compositions out of the range described above more easily than by using conventional methods. Here, it is preferable that the particle diameter of the above-described powder having a large particle diameter be 100 μm or less, because the upper limit of the particle diameter with which it is possible to sufficiently exert the effect described above is 100 μm. In addition, the particle diameter is determined by using the method described in EXAMPLES.

### EXAMPLES

The experiments described below were conducted by using the apparatuses illustrated in FIGS. 1 and 8 (here, the apparatus illustrated in FIG. 7 was used to control the teeming nozzle bore diameter). A raw material was melted by using, for example, a high-frequency induction melting furnace at a predetermined temperature to prepare molten metal 3, and the molten metal was charged into a tundish 2. A molten metal-injecting nozzle 4 having a predetermined nozzle diameter was set in the tundish 2 in advance. After the molten metal 3 was charged into the tundish 2, the molten metal was ejected through the teeming port of the molten metal-teeming nozzle 4 by free fall or under pressure, and atomized, that is, pulverized into fine metal powder, and cooled as a result of cooling water (high-pressure water) ejected from a cooling nozzle 6 at a predetermined water pressure, by a high-pressure pump 17 for atomizing cooling water, colliding with the molten metal. The cooling water was retained in a cooling-water tank 15 in advance, and the cooling water was cooled as needed by a cooling water-temperature controller 16 in some cases.

After soft magnetic iron powder was collected by a hopper, dried, and classified, the iron powder was subjected to X-ray diffractometry to determine halo peaks from amorphous materials (non-crystalline materials) and diffraction peaks from crystals. Then, amorphous material fraction was calculated by using a WPPD method. Here, in the examples of the present invention and the comparative examples, the particle diameter of the soft magnetic iron powder, whose amorphous material fraction was calculated, was +63 μm/−75 μm, and the particle diameter was classified and determined by using a sieve method. The average particle diameter of the obtained Fe-based powder (soft magnetic iron powder) was determined by, after removing contaminants which were different from the soft magnetic iron powder, using a laser diffraction/scattering-type particle size analyzer, and amorphous material fraction was calculated by performing X-ray diffractometry (by using a WPPD method).

In the examples of the present invention, soft magnetic materials having the following chemical compositions were prepared. Seven Fe-based soft magnetic materials having chemical compositions represented by, in terms of atomic percent (at %), Fe₇₆Si₉B₁₀P₅, Fe₇₈Si₉B₉P₄, Fe₈₀Si₈B₈P₄, Fe_{82.8}B₁₁P₅Cu_{1.2}, and Fe_{84.8}Si₄B₁₀Cu_{1.2} for Fe-based soft magnetic materials, Fe_{69.8}Co₁₅B₁₀P₄Cu_{1.2} for an Fe—Co-based soft magnetic material containing Fe and Co in a total amount of 84.8%, and Fe_{69.8}Ni_{1.2}Co₁₅B_{9.4}P_{3.4}Cu_{1.2} for an Fe-based soft magnetic material containing Fe, Co, and Ni in a total amount of 86.0%, were used. Regarding the contents, there may have been an error of about ±0.3 at % or some impurities may have been contained when the raw materials were prepared, and there may have been a slight change in chemical composition due to, for example, oxidation during melting or atomization.

In example 1 of the present invention, chemical composition represented by Fe₇₆Si₉B₁₀P₅ was used, and a diameter of the molten metal-injecting nozzle of 1.9 mm was selected, which resulted in a mass ratio (Qaq/Qm) of 51.

In examples 2 and 3 of the present invention, chemical compositions represented by Fe₇₆Si₉B₁₀P₅, Fe₇₈Si₉B₉P₄, and Fe₈₀Si₈B₈P₄ were used, and the diameter of the molten metal-injecting nozzle was selected so that the mass ratio (Qaq/Qm) was 50 or more (51 to 55) in both the examples 2 and 3. In example 2, the ejection pressure of the cooling water was 25 MPa. In example 3, the temperature of the cooling water was 19° C. (±1° C.)

In example 4 of the present invention, chemical compositions represented by Fe₇₈Si₉B₁₀P₅, Fe₇₈Si₉B₉P₄, Fe₈₀Si₈B₈P₄, Fe_{82.8}B₁₁P₅Cu_{1.2}, Fe_{84.8}Si₄B₁₀Cu_{1.2}, Fe_{69.8}Co₁₅B₁₀P₄Cu₁, and Fe_{69.8}Ni_{1.2}Co₁₅B_{9.4}P_{3.4}Cu_{1.2} were used, the diameter of molten metal-injecting nozzle was selected so that the mass ratio (Qaq/Qm) was 50 or more (50 to 57), the ejection pressure of the cooling water was 25 MPa or more, and the water temperature was 19° C. (±1° C.)

In example 5 of the present invention, chemical compositions represented by Fe₇₆Si₉B₁₀P₅, Fe₇₈Si₉B₉P₄, Fe₈₀Si₈B₈P₄, Fe_{82.8}B₁₁P₅Cu_{1.2}, Fe_{84.8}Si₄B₁₀Cu_{1.2} Fe_{69.8}Co₁₅B₁₀P₄Cu₁, and Fe_{69.8}Ni_{1.2}Co₁₅B_{9.4}P_{3.4}Cu_{1.2} were used, a diameter of the molten metal-injecting nozzle of 0.5 mm to 0.3 mm was selected, nitrogen gas was injected into the tundish to apply pressure to the molten metal so that the mass ratio (Qaq/Qm) was 50 or more (53 to 57), the ejection pressure of the cooling water was 25 MPa or more, and the water temperature was 19° C. (±1° C.)

In the comparative example, chemical compositions represented by Fe₇₆Si₉B₁₀P₅, Fe₇₈Si₉B₉P₄, Fe₈₀Si₈B₈P₄, Fe_{82.8}B₁₁P₅Cu_{1.2}, Fe_{84.8}Si₄B₁₀Cu_{1.2}, Fe_{69.8}Co₁₅B₁₀P₄Cu₁, and Fe_{69.8}Ni_{1.2}Co₁₅B_{9.4}P_{3.4}Cu_{1.2} were used, the diameter of the molten metal-injecting nozzle was selected so that the mass ratio (Qaq/Qm) was 30 to 35, the ejection pressure was 10 MPa, and the water temperature was 32° C.

Among the results of the examples and the comparative examples, it was possible to achieve an amorphous material fraction of 98% or more, which was much larger than 90%, in the case of the examples which were within the range of the present invention. In the case of the comparative example, the amorphous material fraction was less than 90% due to an insufficient mass ratio (Qaq/Qm). From these results, it is clarified that it is possible to increase amorphous material fraction by, for example, controlling the mass ratio (Qaq/Qm) according to aspects of the present invention.

TABLE 1

| | Mass | Pump | Water | Pressure | | | Ferrous | | |
|---|---|---|---|---|---|---|---|---|---|
| Example/ | Ratio | Ejection | Tem- | Applied to | Nozzle | | Constituent | Amorphous | Judgement |
| Comparative | (Qaq/ | Pressure | perature | Molten Metal | Diameter | | [Fe + Ni + Co] | Material | 90% or More: ◯ |
| Example | Qm) | (MPa) | (° C.) | Tundish (MPa) | (mm) | Chemical Composition (at %) | (at %) | Fraction (%) | Less than 90%: X |
| Example 1 | 51 | 10 | 32 | 0 | 1.9 | 1Fe₇₆Si₉B₁₀P₅ | 76.0 | 99 | ◯ |
| Example 2 | 51-55 | 25 | 32 | 0 | 1.9 | 1Fe₇₆Si₉B₁₀P₅ | 76.0 | 100 | ◯ |
| | | | | | 1.7 | 2Fe₇₈Si₉B₉P₄ | 78.0 | 99 | ◯ |
| | | | | | 1.6 | 3Fe₈₀Si₈B₈P₄ | 80.0 | 99 | ◯ |
| Example 3 | 51-55 | 10 | 19 | 0 | 1.9 | 1Fe₇₆Si₉B₁₀P₅ | 76.0 | 100 | ◯ |
| | | | | | 1.7 | 2Fe₇₈Si₉B₉P₄ | 78.0 | 100 | ◯ |
| | | | | | 1.6 | 3Fe₈₀Si₈B₈P₄ | 80.0 | 99 | ◯ |
| Example 4 | 50-57 | 25 | 19 | 0 | 1.9 | 1Fe₇₆Si₉B₁₀P₅ | 76.0 | 100 | ◯ |
| | | | | | 1.7 | 2Fe₇₈Si₉B₉P₄ | 78.0 | 100 | ◯ |
| | | | | | 1.6 | 3Fe₈₀Si₈B₈P₄ | 80.0 | 100 | ◯ |
| | | | | | 1.5 | 4Fe_{82.8}B₁₁P₅Cu_{1.2} | 82.8 | 100 | ◯ |
| | | | | | 1.5 | 5Fe_{84.8}Si₄B₁₀Cu_{1.2} | 84.8 | 99 | ◯ |
| | | | | | 1.5 | 6Fe_{69.8}Co₁₅B₁₀P₄Cu_{1.2} | 84.8 | 99 | ◯ |
| | | | | | 1.5 | 7Fe_{69.8}Ni_{1.2}Co₁₅B_{9.4}P_{3.4}Cu_{1.2} | 86.0 | 98 | ◯ |
| Example 5 | 53-57 | 25 | 19 | 0.05~0.2 | 1.5 | 1Fe₇₆Si₉B₁₀P₅ | 76.0 | 100 | ◯ |
| | | | | | 1.4 | 2Fe₇₈Si₉B₉P₄ | 78.0 | 100 | ◯ |
| | | | | | 1.4 | 3Fe₈₀Si₈B₈P₄ | 80.0 | 100 | ◯ |
| | | | | | 1.4 | 4Fe_{82.8}B₁₁P₅Cu_{1.2} | 82.8 | 100 | ◯ |
| | | | | | 1.3 | 5Fe_{84.8}Si₄B₁₀Cu_{1.2} | 84.8 | 10 | ◯ |
| | | | | | 1.3 | 6Fe_{69.8}Co₁₅B₁₀P₄Cu_{1.2} | 84.8 | 99 | ◯ |
| | | | | | 1.3 | 7Fe_{69.8}Ni_{1.2}Co₁₅B_{9.4}P_{3.4}Cu_{1.2} | 86.0 | 98 | ◯ |
| Comparative | 30-35 | 10 | 32 | 0 | 2.6 | 1Fe₇₆Si₉B₁₀P₅ | 76.0 | 70 | X |
| Example | | | | | 2.5 | 2Fe₇₈Si₉B₉P₄ | 78.0 | 59 | X |
| | | | | | 2.3 | 3Fe₈₀Si₈B₈P₄ | 80.0 | 43 | X |
| | | | | | 2.2 | 4Fe_{82.8}B₁₁P₅Cu_{1.2} | 82.8 | 38 | X |
| | | | | | 2.2 | 5Fe_{84.8}Si₄B₁₀Cu_{1.2} | 84.8 | 35 | X |
| | | | | | 2.2 | 6Fe_{69.8}Co₁₅B₁₀P₄Cu_{1.2} | 84.8 | 33 | X |
| | | | | | 2.2 | 7Fe_{69.8}Ni_{1.2}Co₁₅B_{9.4}P_{3.4}Cu_{1.2} | 86.0 | 33 | X |

### LIST OF REFERENCE SIGNS

2 tundish
3 molten metal
4 molten metal-injecting nozzle
5 nozzle header
6 cooling nozzle
8 metal powder
14 atomizing apparatus
15 cooling-water tank
16 cooling water-temperature controller
17 high-pressure pump for atomizing cooling water
18 pipework for atomizing cooling water
20 cooling water
21 teeming nozzle bore diameter
22 tundish lid
23 inert gas-injecting port
24 pressure gauge
25 relief valve

1. A method for manufacturing soft magnetic iron powder, the method comprising
ejecting high-pressure water to collide with a molten metal stream falling vertically downward, breaking up the molten metal stream into metal powder, and cooling the metal powder, wherein
when a falling rate of the molten metal stream per unit time is defined as Qm (kg/min) and an ejection rate of the high-pressure water per unit time is defined as Qaq (kg/min), a mass ratio (Qaq/Qm) is 50 or more, and
a total content of ferrous constituents (Fe, Ni, and Co) is 76 at % or more.

2. The method for manufacturing soft magnetic iron powder according to claim 1, wherein
an ejection pressure of the high-pressure water is 25 MPa to 60 MPa, and
the total content of the ferrous constituents is 78 at % or more.

3. The method for manufacturing soft magnetic iron powder according to claim 1, wherein
a temperature of the high-pressure water is 20° C. or lower, and
the total content of the ferrous constituents is 80 at % or more.

4. A method for manufacturing soft magnetic iron powder, the method comprising
ejecting high-pressure water to collide with a molten metal stream falling vertically downward, breaking up the molten metal stream into metal powder, and cooling the metal powder, wherein
when a falling rate of the molten metal stream per unit time is defined as Qm (kg/min) and an ejection rate of the high-pressure water per unit time is defined as Qaq (kg/min), a mass ratio (Qaq/Qm) is controlled on the basis of a correlation between the mass ratio (Qaq/Qm) and an amorphous material fraction of soft magnetic iron powder to achieve a desired amorphous material fraction, and
a total content of ferrous constituents (Fe, Ni, and Co) is 76 at % or more.

5. The method for manufacturing soft magnetic iron powder according to claim 4, wherein the mass ratio is controlled by controlling a diameter of a teeming nozzle bore, through which the molten metal stream falls downward, and/or by controlling an ejection pressure of the high-pressure water.

6. The method for manufacturing soft magnetic iron powder according to claim 2, wherein
a temperature of the high-pressure water is 20° C. or lower, and
the total content of the ferrous constituents is 80 at % or more.
